(19) United States
(12) Patent Application Publication
(10) Pub. No.: US 2026/0042312 A1
(43) Pub. Date: Feb. 12, 2026

(54) SECURITY ELEMENT FOR A VALUE DOCUMENT, HAVING A LUMINESCENT SECURITY FEATURE, AND METHOD FOR PRODUCTION THEREOF

(71) Applicant: GIESECKE+DEVRIENT CURRENCY TECHNOLOGY GMBH, Munchen (DE)

(72) Inventors: Andreas RAUCH, Ohlstadt (DE); Matthias PFEIFFER, Munchen (DE); Manfred HEIM, Bad Tolz (DE); Winfried HOFFMULLER, Bad Tolz (DE); Christoph MENGEL, Holzkirchen (DE); Bjorn TEUFEL, Weissach (DE)

(21) Appl. No.: 19/100,674

(22) PCT Filed: Aug. 1, 2023
(86) PCT No.: PCT/DE2023/100565

§ 371 Date: Feb. 3, 2025

(30) Foreign Application Priority Data
Aug. 4, 2022 (DE) 10 2022 002 840.9

(51) Int. Cl. B42D 25/387; B42D 25/373

(52) U.S. Cl. CPC B42D 25/387; B42D 25/373

(57) ABSTRACT

A security element for a value document includes: a first concealed motif region having a first luminescence layer with at least one first excitation wavelength in the UV-A range; and a second concealed motif region having a second luminescence layer with at least one second excitation wavelength in the UV-A range that is different from the at least one first excitation wavelength.

The invention relates to a security element for a document of value, having a luminescent security feature comprising a first luminescent layer of a first concealed motif region and a second luminescent layer of a second concealed motif region, and to a method of production thereof.

Optically variable surface patterns are often used for the production of security features, and are sufficiently well known in the prior art. It is often the case that security features and/or security elements having security features that implement movement effects, for example by means of microreflectors, are used. The prior art discloses, for example, security elements where colors are generated with the aid of nanostructures having structure sizes in the sub-wavelength range.

A combination of micromirrors with nanostructures thereon can create colored rolling effects and/or 3D effects (the “rolling bar” effect using microreflectors is disclosed in DE 10 2010 047 250 A1, and a 3D effect is disclosed in DE 10 2009 056 934 A1). The micromirrors generate essentially the rolling effect and/or the 3D effect, and the nanostructures color these or else can generate multicolored effects in some cases.

In order to improve forgery security, security features and/or security elements sometimes have what are called class 2 features that can be read out with auxiliary equipment, for example a UV lamp. A class 2 feature typically means a security feature that can be authenticated with auxiliary equipment, for example a UV lamp.

It is an object of the present invention to provide a security element having alternative properties and effects.

It is a further object of the present invention to provide a security element having alternative class 2 features.

It is a further object of the present invention to provide a security element having high forgery security.

It is another object to make nondestructive detachment of the security element from an article and/or a substrate difficult or even impossible.

It is a further object for the effect of the security element that can be seen with the aid of auxiliary equipment to appear in a particularly distinctive and/or esthetically pleasing manner to the observer.

It is a further object of the present invention to provide a security element that is not perceived as a disruptive element and allows an article to be safeguarded therewith to have a more esthetically pleasing appearance.

It is another object to provide a corresponding method of producing a security element.

It is also an object to provide a security element having class 2 features that are secure and easy to read out for a user.

At least one of these objects is achieved by the respective subject matter of the independent claims.

In one aspect, a security element for a document of value having a luminescent security feature comprises: a first concealed motif region having a first luminescent layer having at least a first excitation wavelength in the UV-A range; and a second concealed motif region having a second luminescent layer having at least a second excitation wavelength in the UV-A range that differs from the at least one first excitation wavelength.

The security element has additional and/or alternative properties and effects with respect to the security elements already known. The security element especially has an additional and/or alternative class 2 feature with respect to the security elements already known. The security element has high forgery security with respect to the security elements already known. With the aid of auxiliary equipment, the discernible effect of the security element appears particularly distinctive to the observer. Moreover, the security element is not perceived as a disruptive element on a document of value, a product and/or a substrate, and causes an article to be safeguarded therewith to have an esthetically pleasing appearance.

The security element may comprise or constitute a strip, patch and/or filament. The document of value may constitute, for example, a banknote or a document of value for verification of a product value. A security feature comprises the feature with which a security element is provided, by means of which verification can be effected. The security feature of the luminescent security element is a class 2 feature since it is not apparent to the naked eye. The first concealed motif region that has the first luminescent layer and the second concealed motif region that has the second luminescent layer may together form the one or more luminescent security features.

The UV-A region is within a wavelength range between about 315 nm and about 405 nm. The UV-A region comprises the typical wavelengths of what is called black light. Since the excitation wavelengths are each in the UV-A region, the security element can be read out securely and easily for a user. A simple commercial black light phosphor lamp may be sufficient in some cases, for example, to read out the concealed motif regions. By comparison with shorter-wave UV rays, the UV-A region is comparatively harmless to the user, and harmful radiation can, if required, be shielded, for example, by an absorbent material, for example by plastics (plastic spectacle lenses). The two excitation wavelengths are preferably in the range between 350 and 400 nm.

The security element is preferably examined using a UV lamp having switchable excitation radiation, which is switchable in particular between the excitation wavelengths. The UV lamp switches, for example, between two or three of the following three excitation modes: with the first excitation wavelength, with the second excitation wavelength, or with both excitation wavelengths.

In the production of the security element, it is possible, for example, to use the same lamp for curing of an optional UV-curing adhesive as for the readout of the concealed luminescence regions.

The first luminescent layer and/or the second luminescent layer may be excitable by irradiation with light of a discrete wavelength or with light of a continuous spectrum, in each case within the UV-A region. Two illustrative discrete wavelengths are 395 nm and 365 nm. The first luminescent layer and/or the second luminescent layer may each have a single excitation wavelength (or excitation frequency) or multiple excitation wavelengths. A single UV lamp having a continuous wavelength spectrum, for example, may therefore be suitable (solely) in order to excite the two different excitation wavelengths of the first and second luminescent layers.

The first luminescent layer and the second luminescent layer may not only have different excitation wavelengths, but also different emission wavelengths. The emission wavelengths may lie in the visible or nonvisible wavelength range. If the emission wavelengths are in the visible range, the user will perceive a multicolored picture. If an emission wavelength is in the nonvisible region (in the UV region), the information can be read out by a device. This is called a machine-readable security feature.

The providing of two or even more than two luminescent layers therefore has the effect that, firstly, verification can be made more reliable since at least two excitation wavelengths in the UV-A region are required or selectively usable for the readout, and, secondly, esthetic perception of the security feature can be increased since light of several wavelengths or emission wavelengths is emitted and hence the user will perceive a multicolored picture on excitement of luminescence. The emission wavelengths can thus be sufficiently different that light of different colors is emitted in at least two different concealed motif regions.

Two different excitation wavelengths and/or two different emission wavelengths are two wavelengths that differ by at least 5 nm, preferably at least 10 nm and more preferably at least 20 nm in their central and/or discrete wavelengths.

The first luminescent layer and/or the second luminescent layer may be at least partly transparent, especially in the visible wavelength region. It may at least be the case, however, that a luminescent layer is transparent such that light having an excitation wavelength reaches a sufficient penetration depth to bring about luminescent excitement or excitement of luminescence in the luminescent layer, and for emission light then to exit from the luminescent layer.

The expression “concealed motif region” means a region on the security element which is not identifiable without auxiliary equipment, such as a UV lamp for example, and includes a motif concealed therein, an area and/or a pattern which is therefore visible and/or identifiable and/or readable only using said auxiliary equipment.

The security element may also comprise at least one transparency region and/or a perforation region, wherein the first concealed motif region and/or the second concealed motif region are disposed in the transparency region and/or the perforation region of the security element. This means that the first luminescent layer and the second luminescent layer are at least partly in the transparent region and/or the perforation region.

The transparent region allows the light with the excitation wavelength to get from a single side or even from both sides of the security element to the luminescent layer, which is possibly covered with an at least partly transparent layer. Moreover, the transparent region allows the light having the emission wavelength to leave the respective luminescent layer and exit from the security element on one or both sides of the security element. The respective luminescent layers are not covered by an opaque (nontransparent) layer at least on one side in the transparency region, for example by a metal foil or a metal layer. In a sandwich structure, a lowermost foil may be an opaque and/or at least partly transparent foil. In addition, there may be an arrangement of various functional layers above which the first and second luminescent layers are disposed. One or more exclusively transparent layers may be disposed above the luminescent layers, or an opaque layer, such as a metal layer, may be partly disposed above at least one of the luminescent layers. In any case, the transparency region allows light to get to the respective luminescent layers at least from one side of the security element (from “the top” and/or “the bottom”), in order to achieve excitement of luminescence, and, correspondingly, the emission light may also be emitted outward from the respective luminescent layer on at least one side. In other words, a transparency region is a region on the security element that is transparent to the excitement of luminescence with UV light and the emission of luminescence, at least with regard to an exit surface. The luminescent layers are thus not completely covered by an opaque layer at least in the direction of an exit surface (after or and/or downward). Although there is an opaque layer, especially metal layer, in a perforation region, it has been provided with perforating elements. The excitation light and/or the emission light may pass solely through the perforating elements in the metal layer. Otherwise, the same assumptions are applicable as in a transparency region.

A transparency region and/or the perforation region is a region which is recognizable in terms of its shape. In these regions, the luminescent layers are not covered by an opaque layer or not fully covered by the perforating elements.

The first luminescent layer may at least partly overlap with the second luminescent layer, specifically in an overlap region. The first luminescent layer and/or the second luminescent layer and/or a further luminescent layer has a partial or complete overlap with the transparency region(s) and/or with the perforation region(s).

In a sandwich structure, it is optionally the case that one of the at least two luminescent layers is at least partly atop the other luminescent layer. In the overlap region or region of overlap, it is therefore possible for light of two different emission wavelengths to be emitted. Moreover, one concealed motif region may lie atop another concealed motif region, in which case the motifs of the motif regions are visible individually when they are irradiated successively with the respective excitation wavelength, i.e. if firstly only the first and then the second luminescent layer is excited. If both motif regions are irradiated simultaneously with light of the respective excitation wavelengths, the result may be an overlap of the motifs of the two motif regions and/or a color mixing effect of multiple emission wavelengths.

The security element may further comprise at least one at least partly opaque region.

The opaque region is at least partly nontransparent to visible and/or UV light. The opaque region may be arranged at least partly above (i.e. with the layer thereof directly or indirectly atop) the first luminescent layer and/or the second luminescent layer. The opaque region may additionally or alternatively be in an at least partly lateral arrangement alongside the first luminescent layer and/or the second luminescent layer. The opaque region may have one or more colors, where the colors are matched to an emission color, especially with an emission color of the luminescent layer chosen so as to be identical or to have good contrast. An opaque region may comprise a varnish layer, especially a colored varnish layer. An opaque region may, for example in the case of a filter, be opaque for one wavelength range and transparent for another wavelength range. It may therefore be the case under some circumstances that an at least partly opaque region also constitutes an at least partly transparent region.

The first concealed motif region and/or the second concealed motif region may each be smaller in area than the respective corresponding first luminescent layer and/or second luminescent layer, since the motif regions may merely correspond to the regions that are visible to the observer on excitement of luminescence and the first luminescent layer and/or the second luminescent layer may be partly concealed from view by the opaque region.

The opaque region may contain information, motifs and/or shapes that become visible on the security element under incident light and/or under transmitted light. The opaque region may also correspond, for example, to a printed region.

The opaque region and/or the perforation region may comprise a metal layer, where the metal layer may preferably comprise a relief structure which may be and/or form an optically variable surface pattern.

The security element comprising an optically variable surface pattern, the first luminescent layer and the second luminescent layer has additional and/or alternative properties and effects with respect to the security elements already known. The security element especially has additional and/or alternative class 2 features with respect to the security elements already known. The security element has high forgery security with respect to the security elements already known. With the aid of auxiliary equipment, discernible effects of the security element appear particularly distinctive and/or esthetically pleasing to the observer. Moreover, the security element is not perceived as a disruptive element on a document of value, a product and/or a substrate, and causes an article to be safeguarded therewith to have a more esthetically pleasing appearance.

The metal layer is an opaque layer which is opaque, i.e. nontransparent, to light and especially to emitted light that excites luminescence (also “excitation of luminescence”). The optically variable surface pattern is referred to herein as an optically variable primary surface pattern, since it has a visible effect primarily on incidence of visible light before a luminescent layer is excited. The optically variable primary surface pattern may form/map, create and/or constitute a motif with optically variable properties. The motif may comprise an image of a real object, symbols, ornaments, fantasy elements and/or other motifs. The optically variable primary surface pattern may be visible to an observer under incident light in the opaque region(s) and/or in the perforation region(s). This purpose may be served, for example, by daylight incident from the side of the safety element on which the observer is stationed. The optically variable primary surface pattern may be or become visible to the observer especially in the case of incidence of visible light.

The optically variable primary surface pattern described herein may be formed by at least one motif layer having a relief structure, such as a microstructure, a nanostructure and/or a sub-wavelength structure. The at least one motif layer may comprise: a metal layer and preferably an embossment layer, above and/or beneath which the metal layer is disposed.

The perforation of the metal layer by means of the perforating elements may constitute an element pattern. In the region of the element pattern, at least one of the two luminescent layers of the invention may be disposed above and/or below the primary surface pattern. At least one of the at least two luminescent layers may be at least partly transparent.

What is generally essentially meant by the expression “optically variable” is that different impressions become visible or apparent to the observer depending on a viewing angle (including tilting/rotating), a side of the security feature (front side/reverse side), a reflection (front view) and/or a transmission (through view, i.e. toward the light source), where an optically variable security feature may have a color effect, a moving motif, a floating motif and/or a rolling effect. The security element is more preferably optically variable in a viewing angle-dependent manner.

The relief structure, especially the microstructure, the nanostructure and/or the sub-wavelength structure, may comprise an optically variable micro- and/or nanorelief, preferably with dimensions or measurements within and/or below the visible wavelength range, especially holograms, micromirrors, microlenses and/or corresponding or other nanostructures.

The security element may have a front side and a reverse side. The front side is the side facing an observer when viewing the security element as actually intended. The reverse side is therefore the side remote from the observer, which may have been provided, for example, with an adhesive, for example a glue, in order to arrange and/or to fix the security element on a document of value or a product.

The first luminescent layer and the second luminescent layer may lie at least partly in a common plane or in a common plane region.

This means that the first luminescent layer and the second luminescent layer are arranged in a sandwich structure on or beneath a layer, at least partly in a common plane above or below it. It may also be the case that the layer above or beneath has a roughness, such that the first and second luminescent layers cannot be disposed in a flat plane above or below it. This may therefore also be a plane region in which the luminescent layers may be arranged within the roughness.

The effect perceptible to the observer is that, in the case of excitement of luminescence of both luminescent layers, only the first luminescent layer can be visible in front view in a first area region, and only the second luminescent layer can be visible in a second area region. In addition, these luminescent layers may also overlap in some regions, such that, in a third region, an overlap region, the two luminescent layers can become simultaneously visible in the case of excitement of luminescence of the two luminescent layers. If, by contrast, only one of the two luminescent layers is excited, it is correspondingly also the case that only the first or only the second luminescent layer will be visible in the overlap region.

The arrangement of multiple luminescent layers one on top of another and/or one alongside another can create special effects which, in the case of joint excitement of luminescence, may correspond to a multicolored image of a concealed motif. This leads to elevated security in verification by the security element. The security element also has a particularly esthetically pleasing appearance to the observer.

It may also be the case that an overlapping concealed and/or concealing luminescent layer is disposed above the other luminescent layer(s), such that the concealed motif(s) will be difficult or impossible to see in the case of excitement of luminescence of all luminescent layers, since the overlapping concealing luminescent layer will “outshine” the other luminescent layers.

It may therefore be a requirement for verification, especially when there is an overlapping arrangement of a concealing luminescent layer, that the wavelength range for the excitation of luminescence in the UV-A region is known, in order to make the predetermined concealed motif(s) visible. In that case, for example, a wavelength or wavelength range of the excitation of luminescence has to be left clear for the concealing luminescent layer, in order to make the motif(s) visible. This leads to further elevation of security in verification by the security element.

In principle, two or more luminescent layers may also be disposed in different planes and/or on or beneath different layers of a sandwich structure, for example, in order to create different effects.

The first concealed motif region and/or the second concealed motif region may comprise at least one element and/or pattern perforated into the metal layer.

An element perforated into the metal layer may also be regarded as an element that perforates the metal layer (perforating element for short). In other words, the security element, as well as the first luminescent layer and the second luminescent layer, has a perforated metal layer having holes or perforations that may have a shape and through which the first and/or second luminescent layer becomes visible in the event of appropriate excitation of luminescence, and therefore emission light in the shape of the perforations is emitted. The emission light that maps the shape of the perforations may form a concealed secondary surface pattern which becomes visible in a secondary manner, i.e. not on irradiation with a white light but on irradiation with a light of wavelength in the UV-A range. The concealed secondary surface pattern may correspond to a first and/or second motif of the respective first concealed motif region and/or the second concealed motif region.

The perforated metal layer preferably has the aforementioned optically variable primary surface pattern. A white light incident from the side of the security element facing the observer can then be scattered, reflected and/or diffracted at the perforated metal layer with an optically variable primary surface pattern such that an optically variable, viewing angle-dependent motif appears.

The concealed secondary surface pattern, particularly in the case of incidence of daylight and/or from a white light source, can be seen by the observer only with difficulty and preferably not at all. The concealed secondary surface pattern corresponds to at least one of the luminescent layers together with the perforation of the metal layer, especially in the perforation region and/or according to a predetermined pattern. The perforation may be created by stamping, etching material away, laser treatment, washing or another way of removing or demetallizing the metal layer. The concealed secondary surface pattern may form a further motif and/or piece of information by means of the perforating elements or perforating structure or perforating pattern. The perforating elements may form a substructure of the motif. The perforating elements may correspond to a pattern. For example, the elements may have the shape of crosses (as substructure elements) and, in their entirety, together map a cross as the higher structure or shape of the perforation region.

The elements that also perforate the primary surface pattern correspond essentially to demetallized regions of the metal layer, i.e. regions that are not covered and/or coated with the metal layer. Therefore, the metal layer of the primary surface pattern is holey or patchy. The perforating elements may be in a regular or chaotic arrangement in the area. The majority of elements that perforate into the metal layer or the majority of elements that perforate the metal layer (“perforating elements” for short), as already mentioned, form the substructure, where the perforating elements together may form a higher (meaningful) motif. The concealed secondary surface pattern may moreover be machine-readable, i.e. create invisible emission (e.g. UV light) on excitation of luminescence, which is detectable by a measurement device and/or a detector.

The first and/or second luminescent layer may be disposed above and/or beneath at least a portion of the primary surface pattern and/or within the perforating elements or perforations or gaps. The first and/or second luminescent layer may each correspond to a luminophore layer. The regions of the security element (also called film security element) with the demetallized pattern may be implemented as several luminescent layers (at least the first and second luminescent layers) with fluorescent dyes.

The first and/or second luminescent layer may be excited in the UV-A range and may emit light in the visible wavelength range, such that the concealed secondary surface pattern is discernible to the human eye. Additionally or alternatively, the emitted light, as already mentioned, may also lie in the nonvisible wavelength region and therefore be (solely) machine-readable. The concealed secondary surface pattern may thus also comprise a machine-readable security feature that emits a light which is detectable, for example, in the nonvisible wavelength region, especially in the UV-A region. The primary surface pattern, by contrast, may comprise an optical security feature which is apparent in the visible wavelength range.

The combination of the perforating elements corresponding to the demetallized regions in the metal layer and the luminescent layers above, beneath and/or in between has the effect that the concealed secondary surface pattern and possibly a higher motif formed therefrom becomes visible to the observer on excitement of luminescence by UV-A radiation.

In addition, the security element may also have at least partial transparency in the region of the respective perforating elements, such that the concealed secondary surface pattern is visible not only from the side of the security element facing the observer in the event of the respective excitation of luminescence but also in the case of transmitted light, i.e. when a light, which may comprise white light or else a UV-A light, is incident from the side of the security element remote from the observer. The incident light passes here through the layers that are possibly present behind the luminescent layers and metal layer, such that either at least a portion of the white light becomes visible on the side facing the observer or there is excitation of luminescence, and the emission light generated in the corresponding luminescence light becomes visible to the observer. The UV-A radiation may thus be incident from the side facing the observer on the security element and/or from the reverse side thereof, in order to make the concealed secondary surface pattern visible. In this case, it is advantageous or even necessary for the luminescent layers also to be at least partly transparent, such that at least a portion of the light can pass from the reverse side through the security element, especially the luminescent layers, to the side of the security element facing the observer.

Therefore, perforation in this case has the effect that the concealed secondary surface pattern and possibly a higher motif formed therefrom becomes visible to the observer in transmitted light.

In other words, the concealed secondary surface pattern under the action of excitation of luminescence by the UV-A light and possibly also under transmitted light, a concealed motif, a pattern and/or a substructure and possibly a concealed higher motif can become visible on a metallized film security element which is formed from the multitude of small demetallized regions of the concealed secondary surface pattern.

The term “transmitted light” should be understood herein to mean incident light, such as daylight, passing from the side of the security element remote from the observer (reverse side, “from the back”) through the perforations of the secondary surface pattern and/or the element pattern. The element pattern may comprise a further motif and/or a piece of information which is formed by means of the perforating structure (substructure of perforating elements). The secondary surface pattern or element pattern may therefore, in the corresponding embodiments, become visible to the observer in the case of incidence of transmitted light and in the case of incidence of a light in the UV-A range of the appropriate excitation wavelengths which can excite the luminescent materials used.

The security element may generally have a sandwich structure. In this embodiment, the sandwich structure—without stipulating the sequence of layers—may have the metal layer perforated by the elements of the concealed secondary surface pattern with a relief structure of the optically variable primary surface pattern and the two luminescent layers. In other words, the security element may have a sandwich structure having a holey metal layer and at least two luminescent layers arranged alongside one another and/or one on top of another in the region of the holes of the metal layer. In general, a sandwich structure of a security element as described herein may be formed and/or disposed on a carrier, where the carrier can be removed from the sandwich structure. As well as the obligatory and optional layers of the sandwich structure mentioned, there may also be other functional layers that are described somewhat later in the description as possible embodiments. At least one of the at least two luminescent layers (the first and/or second luminescent layer) may be disposed directly above and/or beneath the perforated metal layer and may cover the majority of elements that perforate the metal layer such that the luminescent layer can be irradiated through the perforating elements, i.e. through the holes, and can emit emission radiation or luminescent radiation through the latter, in such a way that a motif becomes apparent to the observer on the transmitted light and/or on excitation of luminescence and arises from and/or is composed of the elements of the concealed secondary surface pattern that perforate the metal layer, but is not apparent under incident visible light.

In order to achieve transparency with simultaneous protection and/or for support of the layers, at least one semitransparent layer having a transparency of at least 25% may be disposed at least in the region of the first and/or second concealed motif region and especially in the region of the concealed secondary surface pattern (preferably in the region of the majority of perforating elements). At least one semitransparent layer may thus be disposed essentially over the full area above and/or beneath the first and/or second concealed motif region and/or the primary surface pattern. The semitransparent layer may moreover have a filter effect, such that particular wavelengths cannot pass through the layer. The semitransparent layer may additionally or alternatively also correspond to a protective layer and/or a supporting carrier layer.

The security element may be mounted on a document of value with the aid of the adhesive material or a tie layer, in such a way that the adhesive material makes contact with a surface of the document of value and/or a substrate. If the adhesive material is radiation-curable—for example comprises UV-curing polymer—it may be cured by irradiation with a suitable wavelength after being positioned on the document of value.

If the tie layer is irradiated through the perforating elements, the tie layer will cure only in places (islands) as a result. The result is adhesion islands in the tie layer. The adhesion islands form better adhesion to the target substrate than the uncured sections of the tie layer surrounding them.

The formation of insular layers of adhesive material is particularly suitable for countering forgeries of documents of value, since nondestructive removal of the security element is impossible. Multipoint fixing of the security element on a document of value can reliably have the effect that the document of value and/or the security element tears when detachment is attempted. It is thus impossible to transfer the security element in a nondestructive manner from a document of value to another object.

The adhesive material or tie layer is preferably at least partly transparent, in such a way that it allows light for excitement of luminescence of the luminescent layer and light emitted as a result from the luminescent layer to pass through, or transmits it, and does not disrupt or even hinder the function and effects of the security element of the invention.

The at least one element perforated into the metal layer may have at least one of the following shapes: a geometric shape, especially a triangular, rectangular, rhombus-like or circular shape, preferably an annular or solid circular shape, especially the form of a dot pattern, an alphanumeric symbol, a symbol, an ornament, a line and a mesh.

In general, the perforating elements may have individual forms and, in their entirety and arrangement, in turn form a higher shape or structure. In other words, the majority of perforating elements (that perforate the metal layer) may have a substructure, where the elements together may form a higher motif. For example—as already mentioned—small cross-shaped elements may form a higher cross. The shapes of the elements may preferably be perceptible as such to the observer and have appropriate dimensions. It is possible, for example, for the shapes to be uniform, for example circular shapes only. There may alternatively be different shapes, such as circular and rectangular shapes.

The perforating elements may have a size—such as length and/or width—of 10-500 μm and preferably of 50-250 μm. The length (or a maximum size in any direction) and width (or a minimum size in any direction) of the perforating elements are preferably within the (preferred) range. Alternatively, only the width is within the (preferred) range. The circular shapes may each have a diameter, for example, of 10-500 μm and preferably of 50-250 μm. The dimensions of the perforating elements may be uniform or nonuniform. With these dimensions of the perforating elements, the shapes thereof may still be visible or apparent under transmitted light and/or on excitation of luminescence. The light reflected and/or scattered under incident light by the metal layer of the primary surface pattern does not outshine the light from the luminescent layers emitted by excitation of luminescence and/or the transmitted light that passes through the perforating elements in each case to any great extent, and so the observer can see that light is passing through the shapes of the perforating elements.

The perforating elements may have a lateral distance from one another of 10-500 μm, preferably 50-250 μm. The distance between the perforating elements is preferably greater than their size. The lateral distance or side distance between two perforating elements may especially be a distance between two mutually facing contour edges of two perforating elements. The lateral distances are chosen herein such that they correspond to the shortest distance between two mutually facing contour edges of two perforating elements. The lateral distances may alternatively also be the distances between the centers and/or geometric centroids or centers. The distances are preferably chosen such that they can be perceived as individual perforating elements, the shape of which is essentially still apparent.

In the region of the perforating elements, the area proportion of the perforating elements (perforation area to perforated area) may preferably be 10% to 60%, preferably 20% to 49%, more preferably 20% to 42%.

The first luminescent layer and/or the second luminescent layer may comprise a fluorescent layer and/or a phosphorescent layer, wherein the fluorescent layer is set up to fluoresce and the phosphorescent layer is set up to phosphoresce.

Luminescence may be regarded as a collective term for luminous effects having essentially no thermal radiation. If the light emits luminescent radiation immediately after excitation of luminescence by the luminophore, i.e. within a period of time of a few microseconds after excitation of luminescence of the luminophore medium, this is typically fluorescence. But if the light is emitted with a longer delay after excitement of luminescence, with the delay typically in the region of seconds or higher, this is phosphorescence. What is specifically described herein is excitation of luminescence by UV-A light. In addition to the required luminescence of the two luminescent layers in the UV-A region, the following types of luminescence may also exist in different excitation ranges in these or additional luminescent layers: photoluminescence outside the UV-A region, x-ray luminescence, sonoluminescence, radioluminescence, chemoluminescence, bioluminescence, triboluminescence, electroluminescence, luminescence of technical luminophores, as in luminophore lamps for example.

A UV lamp for excitation of luminescence of the luminescent layers with UV-A light is easy and uncomplicated to operate, and the security element can be verified rapidly and easily. Photoluminescence typically occurs under and/or after illumination or excitation of luminescence with UV-A light, where the wavelength of the radiation emitted is typically better than that of the exciting radiation since energy is lost as a result of the (electronic) excitation or luminescence excitation.

The optically variable surface pattern may comprise an embossment layer, above and/or beneath which the metal layer may be disposed.

An embossment layer may comprise a polymer, for example a resin and/or varnish, into which a relief is incorporated and/or introduced. The relief is predetermined, and its structure corresponds to the optically variable primary surface pattern. It may have a relief structure, such as a sub-wavelength structure, a nanostructure and/or a microstructure, which, in particular after coating with a metal layer, generates an optically variable and viewing angle-dependent effect, for example an optically variable color impression and/or another optically variable effect, for example a rolling effect, a 3D effect and/or a floating effect, a hologram, a moving effect or the like.

The metal layer may correspond to a thin metal foil and/or correspond to a vapor-deposited, sputter-applied and/or electrochemically applied metal layer. The metal layer may therefore serve as a mirror. The metal used may be a suitable reflector metal, for example aluminum.

The metal layer may be disposed directly or indirectly with the interlayer on, below and/or above the embossment layer. Positioning of a layer above or beneath another layer may generally be regarded as indirect or direct positioning or layer arrangement.

The perforating elements may also perforate the embossment layer and/or other layers, although this is not absolutely necessary but merely optional.

The aforementioned at least one at least partly opaque region may comprise an opaque edge region that at least partly surrounds the first concealed motif region and/or the second concealed motif region, and/or the security element may comprise an at least partly transparent edge region that at least partly surrounds the first concealed motif region and/or the second concealed motif region.

The opaque region is a region essentially opaque to visible light. The first concealed motif region and/or the second concealed motif region, and in particular the metal layer with the primary surface pattern and the secondary surface pattern concealed two-dimensionally therein, may therefore be embedded into the opaque (edge) region, which may for example have a particularly esthetically appealing appearance.

The opaque region may have a uniform color or multiple colors that have a particularly esthetically pleasing appearance. The opaque region may also comprise a coating that comprises and/or covers other elements, for example an adhesive layer and/or an electronic element. The opaque region may comprise an opaque layer or be formed by an opaque layer, where the opaque layer may serve as a substrate and/or support layer, especially for the holey metal layer. Otherwise, the opaque region may be formed from an opaque layer. The opaque region may in any case have been formed or be formed from an opaque layer that supports and/or stabilizes the first concealed motif region and/or the second concealed motif region, and in particular the metal layer, laterally and/or from the underside. It is thus possible to prevent, for example, inadvertent tearing of the metal layer at its sides.

The security element may additionally or alternatively comprise an at least partly transparent (i.e. at least partly nonopaque) region surrounding the first concealed motif region and/or the second concealed motif region, and in particular the metal layer.

An at least partly transparent region that at least partly surrounds the first concealed motif region and/or the second concealed motif region and possibly the metal layer, preferably the perforated metal layer, can give the observer the impression that only the central element, specifically the security element of the invention without additional visible edge regions, is disposed on the document of value. Visible regions that surround the central element, i.e. at least the first concealed motif region and/or the second concealed motif region, and are possibly perceived as being disruptive are thus dispensed with here, with simultaneous provision of sufficient contact area to fix the security element on the document of value and/or substrate. Therefore, this security element may be perceived as being particularly esthetically pleasing and not as a disruptive element on a document of value.

The security element may, for example, be a patch, especially an L patch or a T patch, a strip, especially an L-LEAD or a T-LEAD, or a filament.

Especially in the case that the security element corresponds to a patch, a central region with optically variable features (such as a color shift) including the opaque metal layers may be embedded into a transparent and/or opaque edge region.

It is particularly advantageous to provide a strip and/or a patch or else a filament for safeguarding with the luminescent security feature of the invention, the class 2 feature, in order to increase forgery security thereof.

In general, a security element may therefore be an element which is to be applied to and/or introduced into a substrate. For example, the security element may be applied to a substrate as a strip (for example from end to end of a banknote) or as a patch (in a locally limited manner on a banknote). It is likewise possible to introduce a security element into a substrate as a filament, for example in a paper machine. Patches, filaments or strips may also be introduced into the substrate by arranging them between part-layers of the target substrate.

In general, security elements may be present with or without dedicated carriers. The carrier may have a plastic carrier and/or a film, such as a PET film. The carrier of the security element may thus be applied as well to a target substrate, such as a document of value. It is likewise possible for the security element (or a multitude of security elements) to be disposed on a transfer carrier. The security element is detached from the transfer carrier on transfer to the target substrate. The substrate of the document of value may comprise one or more paper layers or one or more polymer layers or a combination of paper and polymer layers.

A LEAD corresponds to a strip and may extend over the length and/or width of a document of value, for example a banknote. A patch, by contrast, is locally limited, i.e. may be smaller in terms of its dimensions (length and/or width) than the document of value itself. An L patch or L strip corresponds to an applied or introduced patch or strip having its own carrier. Such an L patch or L strip is correspondingly applied to/introduced into a document of value with the carrier. L in this notation stands for application, also referred to in some cases as “laminating”. A T patch or T strip corresponds to an applied and/or introduced patch or strip which is parted from a transfer carrier and applied to/introduced into a target substrate and/or document of value. A T patch may either not have its own carrier or optionally have its own carrier.

In general, a security feature of a security element may, for example, be a feature printed onto a substrate or present within a substrate. A security feature may comprise features that serve to safeguard a banknote, such as printed IR/UV dyes and/or luminescent layers and/or fibers.

In one aspect, a method of producing a security element for a document of value having a luminescent security feature comprises the steps of: arranging a first luminescent layer having at least one first excitation wavelength in the UV-A region in order to create a first concealed motif region; and arranging a second luminescent layer having at least one second excitation wavelength in the UV-A region in order to create a second concealed motif region, where the at least one second excitation wavelength differs from the at least one first excitation wavelength, wherein the emission wavelengths are preferably also different, such that different colors are emitted.

The method of producing the security element has all the advantages and effects of the security element in the corresponding embodiment.

The first luminescent layer and/or the second luminescent layer are preferably printed on. One or both luminescent layers may be vapor-deposited.

The first and second luminescent layers may be disposed in a transparency region and/or perforation region. The method may further comprise positioning a metal layer comprising a relief structure that corresponds to an optically variable surface pattern and/or is opaque in regions and/or has been provided with perforating elements, such that one or more opaque regions and/or one or more perforation regions are formed.

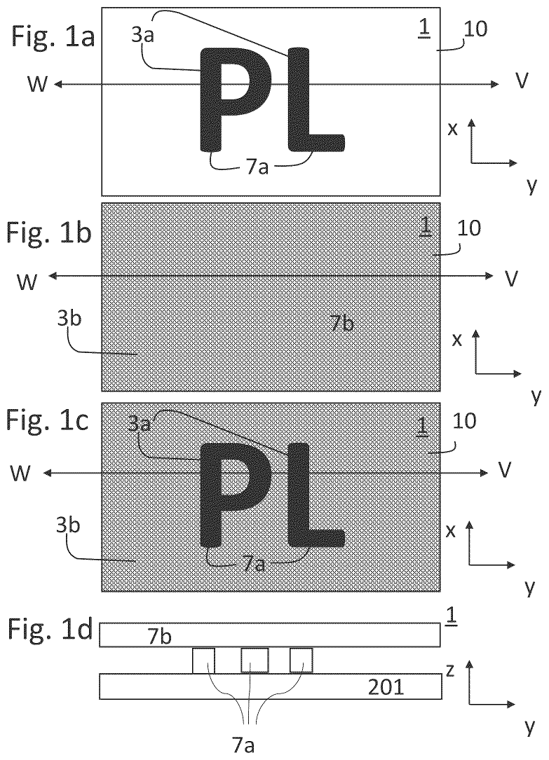

FIG. 1a is a schematic diagram of a security element in one embodiment on excitation of luminescence by means of a first excitation wavelength in the UV-A region, where the first concealed motif region becomes visible;

FIG. 1b is a schematic diagram of the security element in the embodiment of FIG. 1a on excitation of luminescence by means of a second excitation wavelength in the UV-A region, where the second concealed motif region becomes visible;

FIG. 1c is a schematic diagram of the security element in the embodiment of FIG. 1a and FIG. 1b on excitation of luminescence by means of the first excitation wavelength in the UV-A region and the different second excitation wavelength in the UV-A region, where the first and second concealed motif regions become visible;

FIG. 1d is a schematic diagram of a section along the section line through the security element according to the embodiment of FIG. 1a-1c;

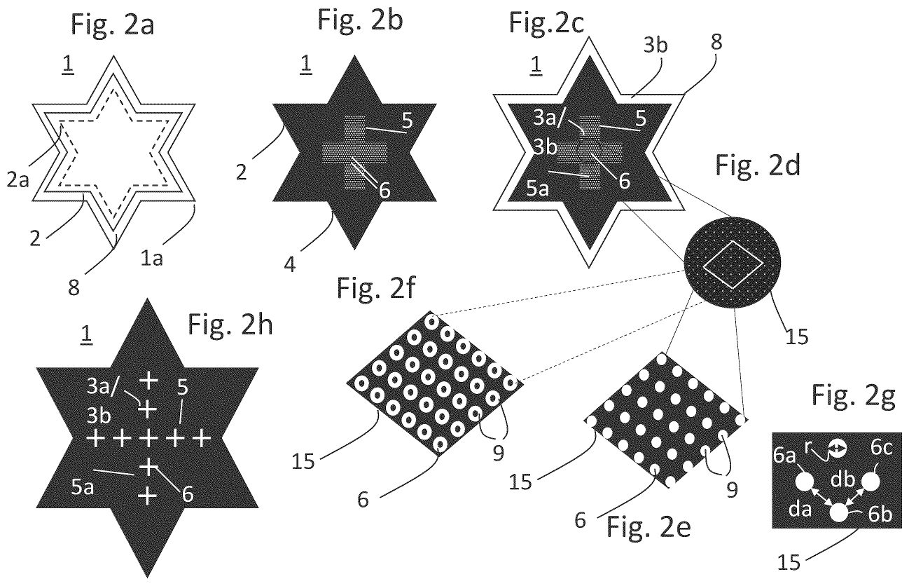

FIG. 2a is a schematic diagram of a security element under incident light in one embodiment;

FIG. 2b is a schematic diagram of the security element of FIG. 1a under transmitted light;

FIG. 2c is a schematic diagram of the security element of FIG. 1a on excitation of luminescence;

FIG. 2d is a detail from the schematic diagram of the security element of FIG. 2c and shows a schematic of some of the multitude of perforating elements of the secondary surface pattern;

FIG. 2e is a detail from the diagram of FIG. 2d in one possible embodiment;

FIG. 2f is a detail from the diagram of FIG. 2d in an alternative embodiment to FIG. 2e;

FIG. 2g is a schematic diagram of perforating elements shown in FIG. 1e;

FIG. 2h is a schematic diagram of a security element under transmitted light and/or on excitation of luminescence in a further embodiment;

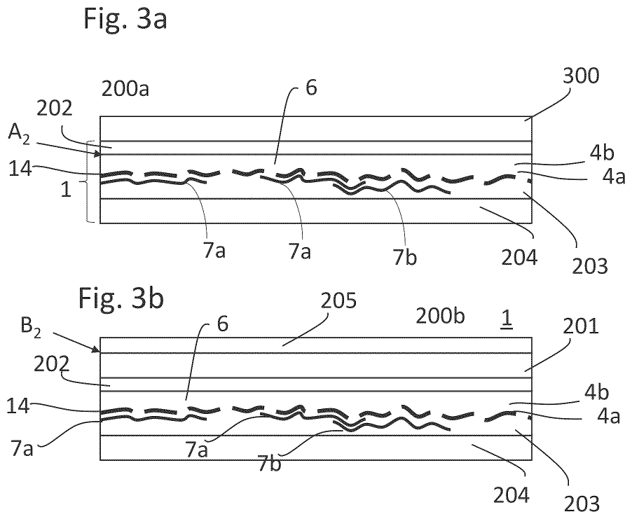

FIG. 3a is a schematic diagram of a layer arrangement of a security element as a T-LEAD in one embodiment;

FIG. 3b is a schematic diagram of a layer arrangement of a security element as an L-LEAD in one embodiment;

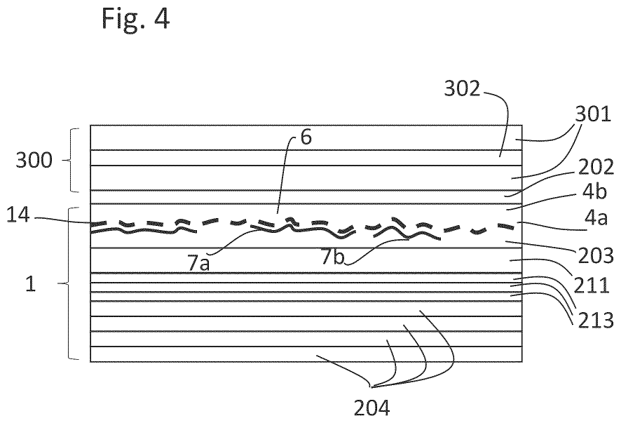

FIG. 4 is a schematic diagram of a layer arrangement of a security element as a patch in one embodiment;

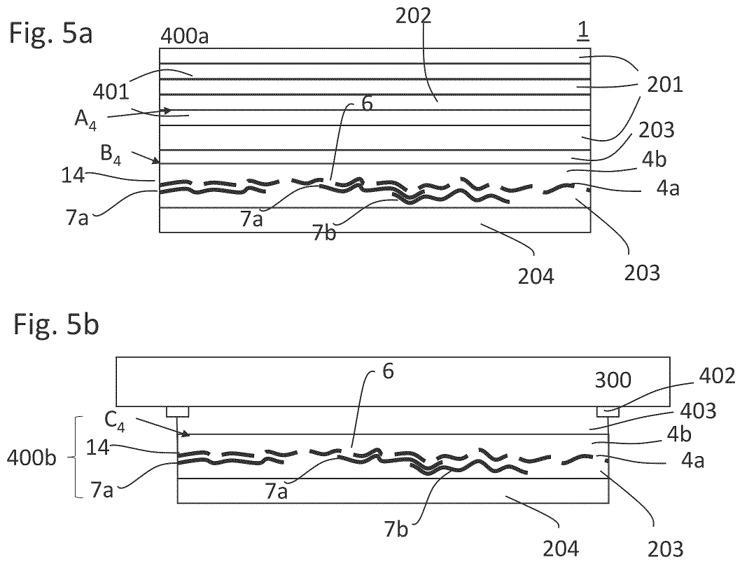

FIG. 5a is a schematic diagram of a layer arrangement of a security element as an L patch in one embodiment;

FIG. 5b is a schematic diagram of a layer arrangement of a security element as a T patch in one embodiment; and

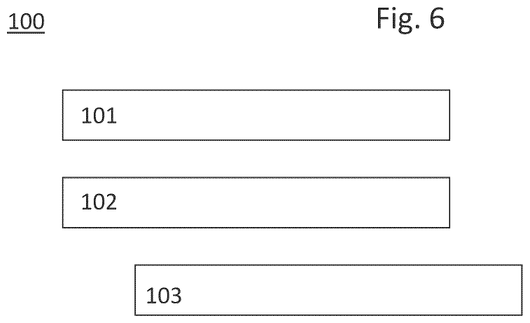

FIG. 6 is a schematic diagram of a method of producing a security element in one embodiment.

Unless stated otherwise, the same reference numerals are used hereinafter for identical and equivalent elements and/or features. Redundant description of recurring features and any redundant use of recurring reference numerals is dispensed with to some degree. The different embodiments and features of the figures described hereinafter are explicitly combinable and should not be regarded as self-contained executions.

FIG. 1a is a schematic diagram of a security element 1 in one embodiment on excitement of luminescence by means of light of a first excitation wavelength in the UV-A region, where the first concealed motif region 3a becomes visible in that the light of the first excitation wavelength excites the first luminescent layer 7a and this emits a light of a first emission wavelength. The first luminescent layer 7a with a first excitation wavelength and a first emission wavelength is in a plane on a carrier, for example of a carrier layer 201 or carrier film, in the form of the letters “PL”. The plane of the carrier, and the plane within which the first luminescent layer is disclosed, is indicated by the x-y plane formed (parallel thereto). Said planes may be arranged essentially parallel to one another. The second excitation wavelength in the UV-A range is omitted in this specific case on excitement of luminescence of the first luminescent layer 7a.

FIG. 1b is a schematic diagram of the security element 1 from FIG. 1a on excitement of luminescence by means of light of a second excitation wavelength in the UV-A region, where the second concealed motif region 3b becomes visible in that the light of the second excitation wavelength excites the second luminescent layer 7b and this emits a light of a second emission wavelength. The first excitation wavelength in the UV-A range is omitted in this specific case on excitement of luminescence of the second luminescent layer 7b. The second luminescent layer 7b with a second excitation wavelength and a second emission wavelength is applied in or parallel to the x-y plane over a large area of the carrier, such that the entire carrier is covered. Since the first and second excitation wavelengths are different, in the case of controlled excitation of luminescence of only the first luminescent layer 7a, only the first concealed motif region 3a can be made visible, and, in the case of controlled excitation of luminescence of only the second luminescent layer 7b, only the second concealed motif region 3b can be made visible.

FIG. 1c is a schematic diagram of the security element 1 of FIG. 1a on excitation of luminescence by means of the light of the first excitation wavelength in the UV-A region and of the light of the different second excitation wavelength in the UV-A region, where the first and second concealed motif regions become visible. The first and second concealed motif regions simultaneously become visible; therefore, the diagram of security element 1 of FIG. 1c corresponds to the superimposition of the diagrams of the security element 1 of FIGS. 1a and 1b.

FIG. 1d is a schematic diagram of a section along the section line W-V through the security element 1 according to the embodiment of FIG. 1a-1c. The diagrams of FIG. 1a-1c show a front view of the security element 1 with the corresponding concealed security feature in the x-y plane. FIG. 1d shows a schematic of the layer arrangement of the first luminescent layer 7a and the second luminescent layer 7b on the carrier layer 201 along the section line W-V, in the y-z plane that runs at right angles to the x-y plane. Therefore, a sandwich structure is shown.

The diagram shows a carrier layer 201 of the security element 1, on which the first luminescent layer 7a is disposed directly. Directly atop the first luminescent layer 7a is positioned the second luminescent layer 7b. The second luminescent layer 7b does not outshine the first luminescent layer 7a on excitation of luminescence by means of the first and second excitation wavelengths, and so the first and second concealed motif regions 3a and 3b become visible. It may be possible here for the superimposition of the two luminescent layers 7a and 7b to achieve a color mixing effect in the region of the first concealed motif region 3a.

The schematic diagram in FIG. 1d can be regarded as a simplified diagram, since there may be further functional layers or plies in the sandwich structure. In particular, further layers that are not shown here first may be disposed between the carrier layer 201 and the luminescent layers 7a, 7b. Moreover, the luminescent layers 7a, 7b may also be arranged one on top of another in the reverse sequence from that shown here, meaning that the second luminescent layer 7b may be disposed atop the carrier layer 201 and beneath the first luminescent layer 7a. Additionally or alternatively, the second luminescent layer 7b may be at least partly in the same plane as the first luminescent layer 7a, parallel to the x-y plane indicated. In general, the security element 1 is larger than the concealed motif regions 3a, 3b (together), or the security element 1 comprises at least one further region outside the motif regions 3a, 3b.

The total area of the security element 1 parallel to the x-y plane (or of the motif regions 3a, 3b) corresponds to a transparency region 10, since there are no layers that cover the luminescent layers 7a, 7b on the side facing the observer. The carrier layer 201 may also be at least partly transparent, and so the reverse side, i.e. the side remote from the observer, is also fully transparent and the two concealed motif regions 3a, 3b can be made visible from the reverse side.

A metal layer 14 perforated in regions may be disposed above the luminescent layers 7a, 7b. In one (or more) perforation region(s), the metal layer comprises elements 6 perforated into the metal layer 14, as elucidated in detail hereinafter by further embodiments.

FIG. 2a is a schematic diagram of a security element 1 under incident light in a further embodiment. FIG. 2b is a schematic diagram of the security element 1 from FIG. 2a under transmitted light and FIG. 2c is a schematic diagram of the security element 1 from FIG. 2a on excitation of luminescence (also “excitation”) with the requisite first and/or second excitation wavelength.

The security element 1 in this embodiment has the outline 1a of a star and can be used for authenticity verification and for safeguarding of a document of value and/or an article of value. The security element 1 comprises an optically variable primary surface pattern 2 which is shown in FIG. 2a and forms a star 2a that has a three-dimensional appearance to the observer. Under incident light, i.e. when visible light, for example white light, falls from the observer's side onto the security element 1, the star 2a that stands out in three-dimensional form from the surface appears as a motif of the primary surface pattern 2, as shown in FIG. 2a. The star 2a which is generated by the optically variable primary surface pattern 2 and appears to stand out from the surface is indicated by the dotted line. The primary surface pattern 2 creates this motif 2a that appears in three-dimensional form since it has a relief structure with a metal layer above that is capable of creating this motif. The relief structure corresponds here to a micro- and/or nanostructure comprising a multitude of mirror elements (such as micromirrors) and/or lens elements (such as microlenses) that can create a viewing angle-dependent effect and hence such a 3D effect.

The metal layer does not fill the entire star shape of the security element 1, but rather forms a smaller star within the outline 1a of a star of the security element 1. The metal layer 14 or the region of the primary surface pattern 2 is surrounded by a transparent (edge) region 8, which forms the region here between the outline 1a and the smaller star-shaped contour of the metal layer 14. The transparent region 8 may form an essentially transparent area. The transparent (edge) region 8 fully surrounds the primary surface pattern 2 (as the inner region). Especially in configurations as strips (and optionally also for a patch), the primary surface pattern 2 is surrounded by exactly two lateral transparent edge regions.

In the transparent region 8, the security element may comprise, for example, the carrier layer and/or an embossment varnish layer and/or a transparent protective layer and/or a tie layer. The layers mentioned may equally be present in the (region of the) primary surface pattern 2, where the metal layer is preferably present atop the embossment varnish layer and/or beneath the protective layer. The transparent region 8 may likewise include regions of the first and/or second luminescent layer as transparent luminescent layer. It is possible to prevent, for example, inadvertent tearing and/or fraying of the metal layer at its sides.

In the region of the primary area pattern 2, the metal layer is in perforated form in some regions. The primary surface pattern 2 in this respect comprises an opaque region 4 and one (or more) perforation region(s) 5. In incident light, these regions of the primary surface pattern are not apparent and therefore not shown in FIG. 2a. The observer sees the motif of the primary surface pattern 2 in the opaque region 4 and in the perforation region 5. The transparent region 8 is preferably barely apparent to the user in incident light, i.e. is not apparent outside a gloss angle in particular.

The embodiment shown is shown merely by way of example in the form of a star, and any other form is conceivable. The indicated three-dimensional effect of the optically variable primary surface pattern 2 is also shown merely by way of example, and the security element may instead or additionally have other effects, such as color effects, rolling effects, floating effects or moving effects.

In incident light alone, as shown in FIG. 2a, the concealed secondary surface pattern 3 is not apparent or perceptible. Only in a situation (in incident light) as shown in FIG. 2b will a perforation region 5 be visible. Only in a situation (excitation of luminescence) as shown in FIG. 2c will the concealed secondary surface pattern 3 be visible or apparent to the observer.

In FIG. 2b, the security element 1 is shown when viewed in transmitted light. The metal layer comprises an opaque region 4 and a perforation region 5 in which there is a multitude of perforating elements 6. The elements 6 that perforate the metal layer are thus lit “from the back”, i.e. from the side of the security element 1 remote from the observer. The perforating circular elements 6 with regular separation from one another and uniform radius form a substructure 15. It will be apparent to the observer that the majority of the perforating elements 6 collectively have the higher shape 5a of a cross. The higher shape 5a of the perforation region 5 with perforating elements 6 may also be referred to as a transmitted light motif of the security element.

In the region of the primary surface pattern 2, there are one (or more) perforated regions 5 and at least one unperforated or opaque region 4. The perforated region 5 is preferably surrounded by an unperforated or opaque region 4. In the present case, the primary surface pattern 2 is in turn surrounded by the transparent region 8. The transparent region 8 is not apparent in transmitted light (and preferably not in incident light either). The substructure 15 is preferably not apparent in transmitted light to the observer's naked eye (without auxiliary equipment).

The concealed secondary surface pattern 3 includes not only the majority of elements 6 that perforate the metal layer but also the at least one first luminescent layer 7a and the at least one second luminescent layer 7b, for example as shown in a similar manner in FIG. 1d or in the subsequent figures. The luminescent layers 7a, 7b may be at least partly transparent, in order to be able to transmit a light from the reverse side. The luminescent layers 7a, 7b in the example shown are disposed in the perforation region 5 of the perforating elements 6. The at least two luminescent layers 7a, 7b may be disposed above, beneath and/or within at least some of the perforating elements 6.

In FIG. 2c, for example, a UV-A light comprising the different excitation wavelengths (the first and second excitation wavelengths) is shone onto the security element 1 for excitation of luminescence of the luminescent material of the two luminescent layers 7a, 7b. The excitation of luminescence (with one or both excitation wavelengths) may be incident in transmitted light (“from the back”, the side of the security element 1 remote from the observer) and/or in incident light (“from the front”, the side of the security element 1 facing the observer). Since the emission wavelengths of the luminescent layers 7a, 7b may also differ, the concealed secondary surface pattern 3 that may comprise the first and second concealed motif regions 3a, 3b may have a multicolored appearance, especially when the luminescent layers 7a, 7b are disposed at least partly alongside one another beneath the perforating elements 6.

The luminescent layer 7a may be present, for example, in the perforation region 5, and the luminescent layer 7b over the full area (or both in the perforation region 5 and in the edge region 8). This is accordingly the appearance—as indicated in FIG. 2c—of the emission of the two luminescent layers, i.e. the concealed motif region 3a and the motif (part-)region 3b in the perforation region 5 and the emission of the second luminescent layer 7b or the motif part-region 3b thereof in the transparent region 8. In the case of excitation of luminescence with solely the first/second excitation wavelength, only the first/second motif part-region 3a/3b will appear. If the emissions of the two luminescent layers are distinguishable in color by the user, the security element is particularly easily verifiable.

Also conceivable, although not shown in FIG. 2c, are other arrangements of the two luminescent layers 7a and 7b or of further luminescent layers in different regions. The luminescent layers could be in an overlapping and/or adjacent arrangement. It would be possible, for example, to consider FIG. 1 as a detail of the motif regions 3a, 3b that are visible within the perforation region 5.

The substructure preferably remains nondiscernible to the observer, to the naked eye, on excitation of luminescence. The observer will see the luminescence of the luminescent layers in the perforated region 5a (and in the transparent region 8) and will be able to discern the shape of the perforated region and/or possibly the subregions of the luminescent layers beneath.

FIG. 2d is a detail from the schematic diagram of the security element 1 of FIG. 2c (or 2b) and shows a schematic of some of the multitude of perforating elements 6 of the secondary surface pattern 3. It is apparent that the perforating elements 6 form a substructure 15 in which the perforating elements 6 are circular, and have a uniform size and mutually uniform separation. FIG. 2c and FIG. 2f are mutually alternative details from the diagram of FIG. 2d in two possible embodiments. According to FIG. 2e, the perforating elements 6 may be circular and cover the full area or be in a dot pattern. Light can thus be transmitted and emitted within the whole area of the circular perforating elements 6. Alternatively, the perforating elements 6 in FIG. 2e may be circular and annular. It is thus possible to transmit and emit light only within the annular region of the perforating elements 6.

FIG. 2e and FIG. 2f are now to be used to briefly describe a further advantageous effect of the perforating elements 6. The security element may comprise a tie layer and/or be secured to a target substrate by means of a tie layer. The tie layer is preferably a (UV) radiation-curable tic layer. If the radiation-curable tie layer is then irradiated through the perforating elements 6 (with appropriate UV light), the tic layer will cure only in places, namely in the region of the perforating elements 6. What is then formed at the time of irradiation or transfer to a target substrate is a tic layer cured only in places (or in insular fashion). FIG. 2e and FIG. 2f indicate, in simplified form, the position of the adhesion islands 9 in the otherwise uncured tie layer, which correspond in size and position to the perforating elements 6 in the metal layer 14 (above). This is an option in order to prevent the security element 1 from being removable nondestructively from the target substrate and transferable to a different substrate and/or object than the original document of value to which it is bonded via the adhesive islands 9. In the event that the security element 1 is pulled away from the document of value, to which it has better bonding in places (by means of the adhesion islands 9), the security element 1 or target substrate will tear. All the perforating elements 6 shown herein may optionally create such cured adhesion islands 9 of glue or another adhesive material without any explicit mention thereof by the corresponding sections of the description that follows or heretofore.

FIG. 2g is a schematic diagram of perforating point elements 6 as shown in FIG. 2e. A first perforating element 6a has a distance da from a second perforating element 6b. The second perforating element 6b has a distance db from a third perforating element 6c. The distances da and db between two most closely adjacent perforating elements 6a, 6b, 6c here are identical to one another. The distances da and db correspond to the shortest distances between the respective outlines of two perforating elements 6a, 6b, 6c. The size, i.e. the radius r, of the perforating elements 6a, 6b, 6c is also uniform here.

The shapes of the perforating elements 6 shown are merely illustrative. It is also possible to use other, nonhomogeneous shapes with nonuniform separation and nonuniform size.

FIG. 2h shows an alternative to the perforating elements 6 so far. FIG. 2h therefore shows a schematic diagram of a security element 1 in the case of excitation of luminescence by means of the UV-A light of the first and second excitation wavelengths (and/or under transmitted light) in another embodiment.

Each perforating element 6 has the shape of a circle. The substructure 15 formed by arrangement of the cross-shaped perforating elements 6 gives rise in turn to a cross as the higher shape 5a. The higher shape 5a and the shape of the perforating elements 6 are apparent to the observer. In the example of FIG. 2h, the individual perforating elements 6 may each be implemented with different luminescent layers 7a, 7b, 7c, for example alternately or in a (multicolor) pattern. Perforating elements 6 may be configured (in terms of size) such that the shape of the perforating elements 6 is apparent to the observer only with auxiliary equipment, such as a magnifying glass or camera (FIG. 2c), or even without auxiliary equipment, to the naked eye (FIG. 2h). Analogously, the substructure 15 may be apparent only with auxiliary equipment, such as a magnifying glass or camera, or be apparent even without auxiliary equipment, to the naked eye.

Alternatively, it would also be possible, for example, for small microscopic symbols, for example an “A”, to give rise to a macroscopic symbol, such as an “A”. It would also be possible, for example, for small microscopic symbols, for example an “A”, to give rise to a microscopic symbol, such as a “B”. In addition, it would also be possible for different symbols, for example “§ &A+T& # . . . ” to give rise to or form a macroscopic number, for example “100”.

Various possible layer arrangements of the security element 1 are shown hereinafter for various embodiments. The layer arrangements each always have the at least one first and at least one second luminescent layer 7a, 7b. The at least one first and at least one second luminescent layer 7a, 7b correspond to two varieties or types of luminescent layers 7a, 7b that have a partial mutual overlap. According to the invention, the two luminescent layers 7a, 7b have different excitation wavelengths and/or emission wavelengths. The configurations already described may exist in all the configurations that follow, especially the regions, including motif regions, perforation region(s), opaque region(s) and/or edge region, even if they are not addressed again or shown in the figures.

FIG. 3a is a schematic diagram of a layer arrangement 200a of a security element 1 as a transfer strip (T-LEAD) on a transfer carrier 300 in one embodiment. The layer arrangement 200a is on the transfer carrier 300 in the form of a carrier film. Firstly applied to the transfer carrier 300 is a release layer 202 (and/or adhesion layer), which firstly bonds the other layers to the transfer carrier 300, but if required-namely in the case of transfer of the security element to a target substrate-permits this to be removed from the transfer carrier 300. The transfer carrier 300 may thus be pulled away from the other layers. The transfer carrier 300 may therefore be considered not to form part of the security element 1.

The release layer 202 adjoins an embossment layer 4b with relief structure 4a and metal layer 14 beneath. The embossment layer 4b with relief structure 4a and metal layer 14 essentially forms the optically variable primary surface pattern 2. In the production, the relief structure 4a may be incorporated into the embossment layer 4b. Subsequently, the metal layer 14 may be applied and/or positioned for mirror reflection. The metal layer 14 has perforations in the form of the perforating elements 6. These perforations, after application of the metal layer 14, may be created in accordance with the different methods described herein. The at least two luminescent layers 7a, 7b may be applied to the perforated metal layer 14, directly or indirectly with an intermediate layer. In the embodiment of FIG. 3a, three illustrative luminescent layers 7a, 7b are present in regions, and these may especially be fluorescent layers. In this case, a first luminescent layer 7a (luminescent layer 7a of the first type, indicated far left) having the first excitation wavelength and the first emission wavelength is not overlapped by the second luminescent layer 7b (luminescent layer 7b of the second type, indicated far right) having a second excitation wavelength and emission wavelength, and another first luminescent layer 7a indicated in the middle, or luminescent layer 7a of the first type, is overlapped by the second luminescent layer 7b having a second excitation and emission wavelength (on the right).

The two luminescent layers 7a, 7b may generally lie alongside one another essentially in a plane or be at least partly layered one on top of another. In this way, the secondary surface pattern may firstly require multiple excitation wavelengths for complete discernibility, but also emit different wavelengths or colors, which appears particularly esthetically pleasing and effective and imparts higher verification quality to the security element 1.

The luminescent layers 7a, 7b are covered by a primer layer and/or protective layer 203 in order to prevent these from becoming detached from the metal layer. An HSL layer as tie layer 204 (HSL: heatsealing lacquer) is disposed atop the primer layer and/or protective layer 203. The security element, i.e. in particular the layers 4b, 14, 7a, 7b and 203, may be secured on a target substrate with the aid of the tie layer 204. The metal layer 14 may be regarded as a layer opaque (nontransparent) to the luminescence excitation light and emission light. However, the luminescent layers 7a, 7b, the HSL layer 204 and the primer layer and/or protective layer 203 are at least partly transparent to the luminescence excitation light and the emission light, such that an observer can see the effect achieved from this side, specifically the concealed secondary surface pattern 3 under excitation of luminescence. It may be the case that the concealed secondary surface pattern 3 is also discernible from the opposite side under excitation of luminescence, especially when the transfer carrier 300 has been pulled away. The release layer 202 may be transparent to light emitted. It may after the transfer of the security element (detachment from the transfer carrier 300). The fact that a carrier layer may remain at least partially or completely on the substrate and/or may be transferred at least partially or completely to the target substrate as well is shown, for example, by FIG. 3b.

The position A₂ indicates an alternative or additional position, between release layer 202 and embossment layer 4b, especially embossment varnish layer, at which there may be disposed the or one or more additional or alternative luminescent layers.

FIG. 3b is a schematic diagram of a layer arrangement 200b of a security element 1 as a strip transferable to the target substrate (L-LEAD) in one embodiment. The layer arrangement 200b differs primarily from that in FIG. 3a in that the carrier layer 201 is part of the security element 1. Optionally, an uppermost color reception layer 205 is additionally present.

The position B₂ indicates a further alternative or additional position, between color reception layer 205 and substrate 201, especially PET layer, at which there may be disposed the or one or more additional or alternative luminescent layers.

FIG. 4 is a schematic diagram of a security element 1 as a patch on a transfer carrier 300 in one embodiment. In particular, there is a multitude of patches (not shown) on the transfer carrier 300. The layer arrangement of the security element, by contrast with the layer arrangements 200a and 200b, has a plurality of HSL sublayers 204, in this case four. The HSL sublayers later collectively form a tie layer to the target substrate. Moreover, the layer arrangement has an optional carrier layer 211 and multiple optional protective layers or primer layers 213.

The transfer carrier 300, in this and in all other configurations, may have two carrier layers 301 that are bonded to one another via a tie layer 302. The transfer carrier 300 comprises the uppermost carrier layer 301, which serves as a support film, and a carrier layer 301 not immediately beneath, which is separated from the support film by a lamination adhesive layer as tie layer 302. As is well known, the layer structure of the security element on such a transfer carrier has particularly good divisibility/separability into regions (for example by stamping or lasering of the layer structure) without tearing the transfer carrier 300 as a result. The three uppermost layers 301 and 302 may be pulled off or removed from the security element 1.

In the layer arrangement of the security element, the luminescent layers 7a, 7b of the two different types (i.e. of the different excitation wavelengths) are arranged alongside one another. The carrier layer 211 of the security element is arranged between the protective layer 203 and the lowermost HSL sublayer 204.

FIG. 5a is a schematic diagram of a layer arrangement 400a of a security element 1 as a patch transferable to a target substrate in one embodiment. The layer arrangement 400a has, in the following sequence: an uppermost PET layer 201, a varnish layer 401, a further PET layer 201, a further varnish layer 401, a further PET layer 201, a primer layer 203, an embossment varnish layer 4b, a perforated metal layer 14, the luminescent layers 7a, 7b of the two different types that are arranged one on top of another and alongside one another, a protective layer 203 and an HSL layer 204. Positions A₄ and B₄ indicate alternative or additional positions where the further or alternative luminescent layers may be disposed, specifically: A₄ between the release layer 202 and the further varnish layer 401, and B₄ between the uppermost primer layer 203 and the embossment varnish layer 4b.

FIG. 5b is a schematic diagram of a layer arrangement 400b of a security element 1 as a T-patch on a transfer carrier 300 in one embodiment. The layer arrangement 400b has, in the following sequence: an uppermost PET layer 301, a first release layer 402 and a second release layer 403, an embossment varnish layer 4b, a perforated metal layer 14, the luminescent layers 7a, 7b of the two different types that are arranged one on top of another and alongside one another, a primer layer 203 and an HSL layer 204. Position C₄ indicates an alternative or additional position where further or alternative luminescent layers may be disposed, specifically: C₄ between the second release layer 403 and the embossment varnish layer 4b.

The described layer arrangements 200a, 200b, 400a, 400b are schematically endowed with the indicated UV-A-active luminescent layers (also UV-A layers). It is also possible for more UV-active and in particular UV-A-active layers, for example three, four, five, six or more, to be present in the layer arrangements. The UV layers may be present alongside one another or one on top of another. Use of such layer arrangements in filaments is also possible. However, this use is fairly limited because the filaments are regularly of small area. Filaments—preferably in a paper machine—are introduced into a paper substrate. All configurations are suitable in principle for introduction between sublayers of a target substrate. In such configurations, for example, it is possible to use a second tie layer disposed on the other side of the security element in order to achieve good adhesion of the security element in the target substrate.

The layers with identical reference numerals and/or designations in the described layer arrangements 200a, 200b, 400a, 400b or in the figures so far may have similar or identical properties, for example transparency or partial transparency; therefore, redundant information is not given specifically for each embodiment.

FIG. 6 is a schematic diagram of a method 100 of producing a security element 1 in one embodiment. The method 100 of producing the security element 1 for a document of value having a luminescent security feature comprises the steps of: arranging 101 a first luminescent layer 7a having at least one first excitation wavelength in the UV-A region in order to create a first concealed motif region 3a; and arranging 102 a second luminescent layer 7b having at least one second excitation wavelength in the UV-A region in order to create a second concealed motif region 3b, where the at least one second excitation wavelength differs from the at least one first excitation wavelength. The emission wavelengths here may also be different, such that different colors are emitted. The first luminescent layer 7a and the second luminescent layer 7b may be disposed 101 in a transparency region 10 or a perforation region 5. The method 100 may comprise further steps, such as the positioning 103 of at least one metal layer. The metal layer is opaque or has been provided with perforating elements in some regions. In this way, the one or more opaque regions and the one or more perforation regions are formed. The metal layer is preferably initially applied over the full area and subsequently provided with the perforating elements. Alternatively or additionally, the metal layer may be provided with a relief structure corresponding to an optically variable surface pattern. Further layers of the security element may be applied in further steps. According to their position in the multilayer structure, the further steps may be effected before, after or between the steps 101-103 mentioned. In a manner known per se, the layers are applied in particular proceeding from the transfer carrier 300, a production carrier, or proceeding from a carrier layer 211 of the security element.

### LIST OF REFERENCE SYMBOLS

1 security element
1a outline of a star
2 (optically variable) primary surface pattern
2a motif (star) with 3D effect, created by the optically variable primary surface pattern
3 (concealed) secondary surface pattern
3a first concealed motif region
3b second concealed motif region
4 opaque region
4a relief structure
4b embossment layer
5 perforation region
5a higher shape (e.g. cross) which is formed by the perforating elements or their substructure
6 perforating element (that perforates the metal layer), or elements perforated into the metal layer
6a a first (perforating) element
6b a second (perforating) element
6c a third (perforating) element
7a first luminescent layer having a first excitation and/or emission wavelength
7b second luminescent layer having a second excitation and/or emission wavelength
8 transparent edge region
9 adhesion islands
10 transparency region
14 metal layer
15 substructure
100 method of producing a security element
101 arranging a first luminescent layer having at least one first excitation wavelength in the UV-A region in order to create a first concealed motif region
102 arranging a second luminescent layer having at least one second excitation wavelength in the UV-A region in order to create a second concealed motif region
103 positioning at least one metal layer
200a layering a security strip onto transfer carrier
200b layering a security strip
201 carrier layer, especially PET carrier film
202 release layer and/or adhesion layer
203 primer or protective layer
204 tie layer
205 color reception layer
211 carrier layer
213 protective layer
300 transfer carrier for security element
301 film layer, especially PET carrier and/or protective film
302 lamination adhesive
211 carrier layer of the security element
213 primer layer or protective layers
400a layer arrangement of a security element as L patch
400b layer arrangement of a security element as T patch on transfer carrier
401 varnish layer
402 release layer 1
403 release layer 2
A position in layer arrangement for alternative or additional luminescent layer
B further position in layer arrangement for alternative or additional luminescent layer
C further position in layer arrangement for alternative or additional luminescent layer
da first distance: lateral distance between first and second perforating elements
db second distance: lateral distance between second and third perforating elements
r radius of a circular element
W-V section line

1.-15. (canceled)

16. A security element for a document of value, comprising:
a first concealed motif region having a first luminescent layer having at least a first excitation wavelength in the UV-A range; and
a second concealed motif region having a second luminescent layer having at least a second excitation wavelength in the UV-A range that differs from the at least one first excitation wavelength.

17. The security element according to claim 16, further comprising at least one transparency region,
wherein the first concealed motif region and/or the second concealed motif region are disposed in the transparency region of the security element.

18. The security element according to claim 16, wherein the first luminescent layer and the second luminescent layer have an at least partial mutual overlap.

19. The security element according to claim 16, further comprising at least one at least partly opaque region and/or at least one (or more) perforation region(s).

20. The security element according to claim 19, wherein the opaque region and/or the perforation region comprises a metal layer, and
wherein the metal layer comprises a relief structure which is an optically variable surface pattern.

21. The security element according to claim 16, wherein the first luminescent layer and the second luminescent layer lie at least partly in a common plane or in a common plane region.

22. The security element according to claim 20, wherein the metal layer in the perforation region comprises at least one element that perforates the metal layer, a multitude of elements that perforate the metal layer and/or a pattern of perforating elements; and/or
wherein the first concealed motif region and/or the second concealed motif region overlap with the perforation region.

23. The security element according to claim 16, wherein the security element also comprises a radiation-activatable tie layer,
wherein an adhesion island in the tie layer is creatable by irradiating the tie layer through the element perforating the metal layer.

24. The security element according to claim 22, wherein the at least one element perforated into the metal layer has at least one of the following shapes: a geometric shape, especially a triangular, rectangular, rhombus-like or circular shape, an annular or solid circular shape, an alphanumeric symbol, a symbol, an ornament, a line and a mesh.

25. The security element according to claim 16, wherein the first luminescent layer and/or the second luminescent layer comprises a fluorescent layer and/or a phosphorescent layer,
wherein the fluorescent layer is set up to fluoresce and the phosphorescent layer is set up to phosphoresce; and/or
wherein the luminescence of the first and second luminescent layers is different, especially different in terms of emission spectrum, which causes different first and second color impressions.

26. The security element according to claim 20, wherein the optically variable surface pattern comprises an embossment layer above and/or beneath which the metal layer is disposed.

27. The security element according to claim 19, wherein the at least one at least partly opaque region at least partly surrounds the first concealed motif region and/or the second concealed motif region and/or the perforation region and/or
the opaque region and/or the perforation region form an inner region of the security element which is surrounded by exactly one circumferential transparent edge region or by exactly two laterally delimiting transparent edge regions.

28. The security element according to claim 16, wherein the security element is a patch, especially a laminating patch or transfer patch, a strip, especially a laminating strip or transfer strip, or a filament; and/or;
both excitation wavelengths are in the UV-A range between 315 and 405 nm, between 350 and 400 nm.

29. A method of producing a security element for a document of value having a luminescent security feature, comprising the steps of:
arranging a first luminescent layer having at least one first excitation wavelength in the UV-A region in order to create a first concealed motif region; and
arranging a second luminescent layer having at least one second excitation wave-length in the UV-A region in order to create a second concealed motif region, where the at least one second excitation wavelength differs from the at least one first excitation wavelength.

30. The method according to claim 29, wherein the first and second luminescent layers are disposed in a transparency region and/or a perforation region, and wherein the method further comprises:
positioning a metal layer which
comprises a relief structure that corresponds to an optically variable surface pattern, and/or
is opaque and/or provided with perforating elements in some regions, giving rise to one or more opaque regions and/or one or more perforation regions.
